(19) United States
(12) Patent Application Publication
(10) Pub. No.: US 2022/0402005 A1
(43) Pub. Date: Dec. 22, 2022

(54) METHODS FOR SAFE DISPOSAL OF MERCURY FROM MERCURY-CONTAMINATED WASTE

(71) Applicant: US Ecology Holdings, Inc., Boise, ID (US)

(72) Inventors: Thomas Patrick Caswell, Ann Arbor, MI (US); Brian Patrick Lindman, Boise, ID (US)

(21) Appl. No.: 17/807,598

(22) Filed: Jun. 17, 2022

Related U.S. Application Data
(60) Provisional application No. 63/202,653, filed on Jun. 18, 2021.

(51) Int. Cl. B09B 3/20; B09B 1/00

(52) U.S. Cl. CPC B09B 3/20; B09B 1/00

(57) ABSTRACT

A method for treating and disposing of mercury—from mercury-contaminated waste—includes recovering high-purity mercury (e.g., greater than about 99.0 wt. % elemental Hg) from the mercury-contaminated waste. The high-purity mercury is converted to mercuric sulfide (HgS). The mercuric sulfide (HgS) is intermixed with a polymer-based material to form an encapsulated mercury material. The encapsulated mercury material is disposed within a sealed waste container. The sealed waste container is disposed of at a landfill site. Also disclosed is a mercury-including waste product that comprises pellets. The pellets comprise mercuric sulfide within a polymer material.

### CROSS-REFERENCE TO RELATED APPLICATION

This application claims the benefit under 35 U.S.C. § 119(e) of U.S. Provisional Patent Application Ser. No. 63/202,653, filed Jun. 18, 2021, the disclosure of which is hereby incorporated in its entirety herein by this reference.

### TECHNICAL FIELD

Embodiments of the present disclosure relate generally to waste management. More particularly, embodiments of the disclosure relate to treatment and safe disposal of mercury from mercury-contaminated waste, such treatment including encapsulation of mercuric sulfide (also known as “mercury(II) sulfide,” “cinnabar,” and “cinnabarite”), derived from high-purity mercury recovered from mercury-contaminated waste, and subsequent disposal of the encapsulated material in a dedicated landfill site.

### BACKGROUND

Mercury is a naturally occurring element and toxic substance that poses serious risk to human and ecological health through both natural and anthropogenic releases into the environment. While economic use of mercury has steadily declined with growing concerns posed by its toxicity, mercury continues to be released through industrial practices and re-released through disruption of historically deposited mercury waste. Some of the primary sources of mercury released through industries in the United States today include mercury produced as a byproduct from the extraction process of gold in mining, as a byproduct from the production of sodium hydroxide (NaOH) using mercury cells in chloralkali plants, and through combustion of fossil fuels. Most uses of mercury (e.g., in paints, in batteries) have been phased out or rely on recycled/reused material (e.g., chloralkali plants). Small amounts of mercury continue to be used in commercial products, such as light bulbs, thermometric devices, switches, and dental amalgam.

Under current regulations applicable to mercury-contaminated waste, only high-purity elemental mercury recovered from current treatment standards is acceptable for storage. Therefore, hazardous wastes contaminated with mercury are first be treated to remove elemental mercury prior to disposal of the waste. Mercury-contaminated wastes are categorized based on total mercury and subject to limitations on disposal thereof. “Low mercury wastes” (having less than 260 mg/kg total mercury), while subject to treatment to prevent leaching of mercury, are allowed disposal to designated “Subtitle C” landfill(s). “High mercury wastes” (having greater than or equal to 260 mg/kg total mercury) are subject to mercury removal through retort/roasting or incineration if organics are present.

Conventional methods for disposing of high mercury waste most commonly involve retort and reuse. These conventional methods have been proven effective at removing elemental mercury from contaminated waste, allowing the waste to then be sent to a suitable landfill for disposal.

Retorting of mercury-contaminated wastes uses a thermal processing unit to volatilize mercury and distill the condensate, which results in the generation of elemental mercury. By retorting the mercury-contaminated waste, the waste is treated to remove the mercury from the waste before disposing of the waste. The distillation of mercury by the retort process tends to produce high-purity element mercury of at least 99.5 percent by volume, which is suitable for storage and reuse in commercial applications.

Though high-purity elemental mercury may be recovered from contaminated waste by conventional means, current regulations have resulted in a growing stockpile of the elemental mercury without a permanent solution to its disposal. That is, as excess elemental mercury was present in the market prior to the 2008 Mercury Export Ban Act (MEBA) and with little market for retorted mercury in the United States, retorted mercury is currently being stockpiled/stored at various facilities across the United States or shipped (in compound form) to Canada for disposal. Therefore, while the conventional retort process is effective at reclamation of elemental mercury from mercury-contaminated wastes, retort is no longer a viable treatment for mercury because the product derived from this process no longer has a market. Thus, the retort process is not a final or permanent treatment method.

In 2018, materials collected for recycling and mercury reclamation via retorting included automobile switches, barometers, dental amalgam, fluorescent bulbs, computers, and medical devices. Since mercury is no longer present in most paints and batteries, recycling of these products has declined. The recycling rate for mercury-containing materials has been low and is declining (10% in the US and less than 10% worldwide), and storage costs have further disincentivized recycling.

Also, current regulations (e.g., the 2011 enactment of the European Union mercury export trade ban) prohibit export of elemental mercury, including that which is produced from conventional treatment methods. Only mercury compounds may be exported. Shipping mercury compounds to Canada or to other locations is not a long-term solution for disposing of the growing stockpile of the United States' domestic mercury from industrial sources and retorts. And, while export bans may provide more motivation for recycling of mercury-contaminated waste, storage of the mercury recovered from such waste is still a challenge. Accordingly, currently, reuse of recycled/retorted mercury in the US markets is declining, and there is an excess supply and some mercury must remain in long-term storage.

No treatment or disposal standards have yet been established by the Environmental Protection Agency (EPA) for the treatment or disposal of high-purity mercury. Therefore, the stockpiles of high-purity (e.g., elemental) mercury continue to grow and will likely only increase in the future without a permanent disposal solution. A long-term management solution, for permanent disposal of element mercury (e.g., high-purity mercury), is needed in the United States to resolve the otherwise-growing stockpiles.

### BRIEF SUMMARY

In some embodiments, a method for disposing of high-purity mercury—recovered from mercury-contaminated waste—includes encapsulating mercuric sulfide (HgS) in a polymer-based material to form an encapsulated-mercury material. The encapsulated-mercury material is sealed within a sealed container. The sealed container is disposed of within a landfill.

According to some embodiments, a method for treating and disposing of mercury—from mercury-contaminated waste—includes recovering high-purity mercury from the mercury-contaminated waste. The high-purity mercury is converted to mercuric sulfide (HgS). The mercuric sulfide (HgS) is intermixed with a polymer-based material to form an encapsulated mercury material. The encapsulated mercury material is provided into a sealed waste container. The sealed waste container is provided into a landfill site.

Further, according to some embodiments, a mercury-including waste product comprises pellets that comprise mercuric sulfide within a polymer material.

### BRIEF DESCRIPTION OF THE DRAWINGS

FIG. 1 is a flowchart of a process for treating and disposing of mercury from mercury-contaminated waste, according to embodiments of the disclosure.

FIG. 2 is a schematic illustration of a mixture, including mercuric sulfide particles in an encapsulating material, which mixture may be prepared and used in the method of FIG. 1.

FIG. 3 is a schematic, cross-sectional illustration of an encapsulated-material structure, which may be formed from the mixture of FIG. 2 in the course of the method of FIG. 1, wherein the encapsulated-material structure includes, throughout, the mercuric sulfide particles within a polymer-based matrix, in accordance with embodiments of the disclosure.

FIG. 4 is a schematic, cross-sectional illustration of an encapsulated-material structure, which may be formed from the mixture of FIG. 2 in the course of the method of FIG. 1, wherein the encapsulated-material structure includes at least one mercuric sulfide particle at a core and further includes a polymer-based shell around the core, in accordance with embodiments of the disclosure.

FIG. 5 is a schematic, cross-sectional illustration of an encapsulated-material structure, which may be formed from the mixture of FIG. 2 in the course of the method of FIG. 1, wherein the encapsulated-material structure includes, throughout a core thereof, the mercuric sulfide particles within a polymer-based matrix, and further includes a polymer-based shell around the core, in accordance with embodiments of the disclosure.

FIG. 6 is an illustrative photograph of a sealable container for sealing therein the encapsulated-material structure(s) of FIG. 3, FIG. 4, and/or FIG. 5 for disposal, in accordance with embodiments of the disclosure.

FIG. 7 is a graphic illustration of a dedicated landfill site for receiving and disposing therein the encapsulated-material structure(s) of FIG. 3, FIG. 4, and/or FIG. 5, such as directly or after sealing the structure(s) within sealed containers such as that of FIG. 6, in accordance with embodiments of the disclosure.

### DETAILED DESCRIPTION

Disclosed is a method for the safe disposal of mercury (e.g., from mercury-contaminated waste), such as in a designated hazardous waste landfill site (which may be otherwise referred to herein as a “monofill,” a “monofill site,” and/or a “designated landfill”). Mercury-contaminated waste may be treated (e.g., subjected to distillation, such as retorting) to recover high-purity, elemental mercury (Hg) from the mercury-contaminated waste. The high-purity elemental mercury is then converted into mercuric sulfide (HgS, also known as “mercury(II) sulfide,” “cinnabar,” and/or “cinnabarite”), which is a more stable form of mercury. The mercuric sulfide is then encapsulated within a polymer (e.g., linear low-density polyethylene (LLDPE)). The encapsulated material may then be directly disposed of in a mercuric sulfide monofill (e.g., a type of landfill specific to mercuric sulfide waste) at an approved facility in an appropriate environment (e.g., an arid environment). Alternatively, the encapsulated material may be packaged (e.g., sealed) within waste containers (e.g., polymer-based closed head drums, such as high-density polyethylene (HDPE) closed head drums), and the waste containers may be finally disposed of in the mercuric sulfide monofill. Whether the encapsulated material is directly disposed in a monofill or is contained within a waste container before disposal, the polymer encapsulant material may inhibit leaching of the mercury into surrounding structures and materials. Accordingly, methods of embodiments of the disclosure provide a treatment solution for elemental mercury that is permanent and secure with a disposal solution that is functionally superior to stockpiling and while providing a high level of protection for human health and the environment.

The illustrations presented herein are not actual views of any particular material, structure, method stage, apparatus, component, assembly, or location but are merely idealized representations that are employed to describe example embodiments of the present disclosure. Additionally, elements common between figures may retain the same numerical designation.

The following description provides specific details, such as process conditions and parameters, features, compositions, properties, and/or other characteristics, in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry. In addition, the description provided below may not describe all parameters, conditions, techniques, compositions, or other features of a complete method. Only those parameters, conditions, techniques, compositions, or other method features necessary to understand the embodiments of the disclosure are described in detail below. Additional features and/or acts may be included and/or performed, respectively, according to conventional features and/or techniques, respectively. Also note, the illustrated drawings accompanying the present application are for illustrative purposes only, and are thus not necessarily drawn to scale.

As used herein, “high-purity,” when referring to a material comprising a chemical, means and refers to the material comprising at least 99.0 wt. % the chemical, e.g., at least 99.5 wt. % the chemical, e.g., at least 99.9 wt. % the chemical, e.g., at least 99.99 wt. % the chemical.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may,” when used with respect to a material, structure, feature, or method act (e.g., process), indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating a parameter, property, condition, or operation (e.g., assembly, storage, transport, use) of one or more of the at least one structure and the at least one apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, the terms “about” or “approximately,” when used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0% to 102.0% of the numerical value, such as within a range of from 95.0% to 105.0% of the numerical value, within a range of from 97.5% to 104.5% of the numerical value, within a range of from 99.0% to 101.0% of the numerical value, within a range of from 99.5% to 100.5% of the numerical value, or within a range of from 99.9% to 100.1% of the numerical value.

As used herein, the singular forms “a,” “an,” and “the” are intended to include the plural forms as well, unless the context clearly indicates otherwise.

As used herein, an “(s)” at the end of a term means and includes the singular form of the term and/or the plural form of the term, unless the context clearly indicates otherwise.

As used herein, the term “and/or” includes any and all combinations of one or more of the associated listed items.

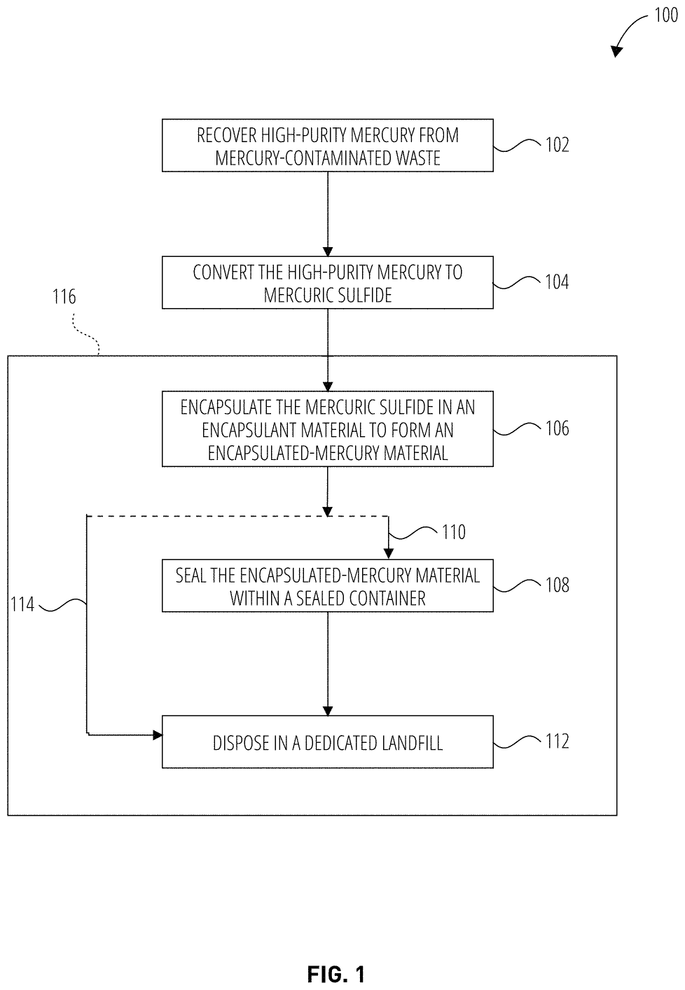

FIG. 1 is an illustrative flowchart for a process 100 for treating mercury-contaminated waste and for safely disposing of mercury recovered therefrom, in accordance with embodiments of the disclosure.

In stage 102, mercury-contaminated waste may be treated to recover high-purity, elemental mercury (Hg) therefrom. The treatment for the mercury-contaminated waste may be tailored according to the source of the contaminated waste. In the United States of America, sources of mercury-contaminated waste include, but are not limited to, gold mining, chloralkali plants, dental uses (e.g., dental amalgam), and recycling (e.g., lights, switches, batteries, paint).

With regard to gold-mining waste, secondary mercury is commonly paired with gold-bearing ores found in gold mines. Mercury is produced as a byproduct during the gold extraction process. That is, when roasting ore to remove sulfides and carbon, mercury is produced as a byproduct. Elemental mercury is directly recoverable (e.g., in stage 102) from such gold-mining waste by roasting the ores (e.g., retorting) or from additional treatment methods to remove elemental mercury. Thus, stage 102 may include recovering elemental mercury from pollution control devices and mercury condensate from the retort processes. Depending on the mine and nature of the processing method, mercury-bearing wastes and sludges may also be produced and may be further treated (e.g., in additional performance of stage 102) to extract further elemental mercury.

With regard to mercury-contaminated waste from chloralkali plants, these plants produce chlorine and sodium hydroxide through electrolysis of sodium chloride. Mercury has historically been used as the cathode in the electrolysis process, and sodium amalgamates to the mercury. Mercury waste generated from this process may be (e.g., in stage 102) retorted to derive the mercury. While chloralkali plants using mercury have steadily declined, and most are shut down or use another process, mercury is still being reclaimed from these closed plants as they undergo decommissioning and cleanup, such as from contaminated soil and water at or around plant sites.

With regard to mercury-contaminated waste from dental uses, such waste is often dental amalgam. In dentistry, mercury was once often used to amalgamate other alloys, such as silver, tin, and copper, to form a strong durable filling material. These amalgamations continue to be used today, though several alternatives are being used due to safety concerns. Waste generated from dental amalgam is typically from recycling. One of the largest sources of mercury waste from dental uses is the filling material itself, which is estimated at 290 metric tons in the U.S. population. Projected deaths and cremations of individuals with mercury amalgam fillings accounts for the largest contributor of mercury waste into the environment as a result of dental amalgam use. This dental-use, mercury-contaminated waste may be treated (e.g., by retorting and/or other processes in stage 102) to recover high-purity elemental mercury therefrom.

With regard to mercury-contaminated waste in recycling streams, this currently produces the largest volume of mercury-containing waste, though available data on the annual production are poorly understood. Such mercury-containing, recycled products include laboratory packs, thermometric devices, lighting (bulbs), switches and relays, batteries, and paint. These products may be processed to recover (e.g., in stage 102) high-purity elemental mercury therefrom.

In some embodiments, the technique for recovering high-purity, elemental mercury from the mercury-contaminated waste (stage 102) may include retorting or roasting the mercury-contaminated waste and then distilling to recover the elemental mercury. That is, following retorting, the waste may be put through a distillation process to recover the elemental mercury. In some embodiments, the distillation process may be single distillation process or a multi-distillation (e.g., triple distillation) process. A high-purity (e.g., at least about 99 wt. % mercury, at least about 99.9 wt. % mercury, at least about 99.99 wt. % mercury) may be recovered from the distillation process.

In some embodiments, such as with more complex mercury-including waste streams (e.g., calomel), additional treatment may be performed between retorting and distillation.

Following distillation or otherwise recovering high-purity elemental mercury from the mercury-contaminated waste (stage 102), the high-purity elemental mercury is converted to mercuric sulfide (stage 104). Converted mercuric sulfide is stable, generally insoluble in mineral form under most environmental conditions, and chemically similar to mercuric sulfide occurring naturally in the environment. Being chemically equivalent to naturally occurring mercuric sulfide, the converted mercuric sulfide of the process 100 of embodiments of the disclosure may not be readily oxidized. The converted mercuric sulfide material it may be in solid particle (e.g., powder) form.

Various techniques for converting high-purity, elemental mercury to mercuric sulfide are known in the art, and so are not described in detail herein. In some embodiments, the resulting mercuric sulfide particles (e.g., powder) may be high purity.

Rather than stockpiling the converted mercuric sulfide material or exporting the converted mercuric sulfide material for disposal, as in conventional methods for handling mercury compounds derived from mercury-contaminated waste, the converted mercuric sulfide material derived from methods of embodiments of the disclosure is further treated, in accordance with embodiments of the disclosure, so that the mercury-including material may be safely disposed of.

The mercuric sulfide material (e.g., particles, such as powder, of mercuric sulfide) is then be encapsulated in an encapsulant material (stage 106). Encapsulating the material may limit the potential exposure of the mercuric sulfide material into the atmosphere, mitigating potential reactions. The encapsulant may also inhibit leaching of the mercury—from the mercuric sulfide—into surrounding materials and structures.

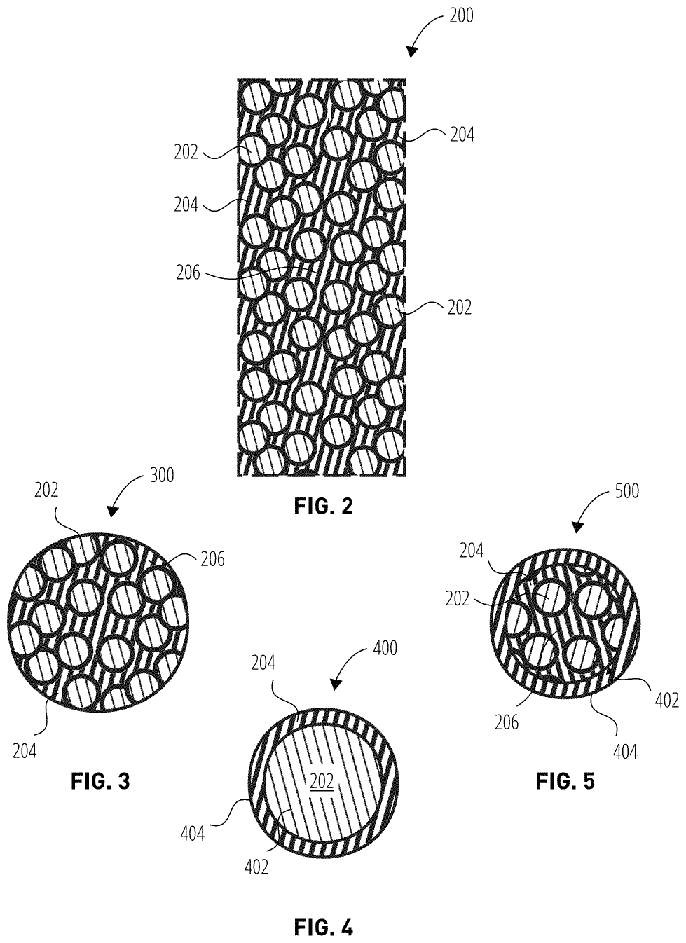

In some embodiments, stage 106 includes forming a mixture 200, illustrated in FIG. 2, from the mercuric sulfide material (e.g., mercuric sulfide particles 202) formed from converting the high-purity elemental mercury (stage 104) recovered from the mercury-contaminated waste (stage 102). For example, the mercuric sulfide particles 202 may be intermixed with an encapsulant material 204.

The encapsulant material 204 may be formed of or include one or more polymer-based material(s), such as a polyethylene material (e.g., linear low-density polyethylene (LLDPE)). At the time of intermixing, the polymer-based material may be in a flowable form (e.g., particulate (e.g., powder) form, plasticized, melted, at least partially dissolved in a liquid solvent, etc.). The mixture 200 may be stirred to promote an even distribution of the mercuric sulfide particles 202 within the encapsulant material 204.

In some embodiments, the encapsulant material 204 may be in powder form at the time of intermixing with the mercuric sulfide particles 202 to form the mixture 200, and the mixture 200 may then be heated to a melting point of the encapsulant material 204 (e.g., to a temperature within a range from about 115° C. to about 135° C. (about 240° F. to about 275° F.) for embodiments in which the encapsulant material 204 is formed of or includes LLDPE).

Solid structures (e.g., pellets, nuggets, particles, blocks, or the like) may then be formed from the mixture 200 (e.g., with plasticized and/or melted) encapsulant material 204) to form an encapsulated-mercury material, such as the pellets 300, 400, and/or 500 of FIG. 3, FIG. 4, and/or FIG. 5, respectively. In some embodiments, the pellets 300, 400, and/or 500 are formed by extruding the mixture 200 through a die.

With reference to FIG. 3, in some embodiments, pellets 300 formed from the mixture 200 include the mercuric sulfide particles 202 substantially evenly distributed—in each or at least some of the pellets 300—within a matrix 206 phase provided by the encapsulant material 204.

With reference to FIG. 4, in some embodiments, pellets 400 formed from the mixture 200 include one or more of the mercuric sulfide particle(s) 202 providing a core 402 of a single one of the pellets 400 with a shell 404 provided by the encapsulant material 204. In some such embodiments, the mercuric sulfide material is wholly enclosed by the encapsulant material 204.

With reference to FIG. 5, in some embodiments, pellets 500 formed from the mixture 200 include, as the core 402 thereof, the mercuric sulfide particles 202 within the matrix 206 of the encapsulant material 204. The shell 404 of the encapsulant material 204 may surround the core 402. Accordingly, in some such embodiments, the mercuric sulfide material is wholly enclosed by the encapsulant material 204.

Structures formed from the mixture 200 may include one or more of the pellets 300 of FIG. 3, the pellets 400 of FIG. 4, the pellets 500 of FIG. 5, and other solid structures derived from the mixture 200 and including the mercuric sulfide material (e.g., powder) within the encapsulant material 204.

Accordingly, disclosed is a mercury-including waste product comprising pellets that comprise mercuric sulfide within a polymer material.

In accordance with embodiments of the disclosure, the encapsulant material 204—and therefore the resulting encapsulated material (e.g., the pellets 300, 400, and/or 500 of FIG. 3, FIG. 4, and/or FIG. 5)—may be free of, e.g., cement or cement-based slurries that may be conventionally used to harden material for landfills.

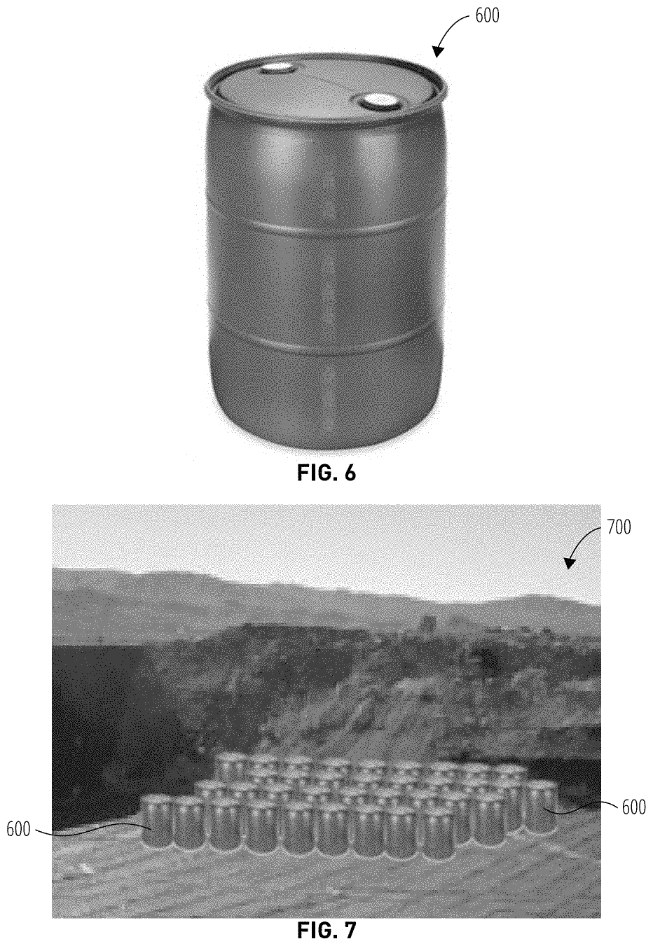

After encapsulation (stage 106 of FIG. 1), the encapsulated material (e.g., the pellets 300, 400, 500 of FIG. 3, FIG. 4, and/or FIG. 5, respectively), may be placed into one or more sealable containers 600 (stage 108 of FIG. 1), as indicated by path 110 of FIG. 1. By way of non-limiting example, the sealable containers 600 may be as depicted in FIG. 6. In some embodiments, one or more of the sealable container(s) 600 are constructed of a polymer-based material (e.g., formed of or including polyethylene, such as a high-density polyethylene (HDPE)). As used herein, “sealable” means and refers to configured for defining therein an environment that is water-tight, air-tight, or other fluid-tight. In some embodiments, the sealable container 600 is a closed head, HDPE, 55-gallon drum.

Each sealable container 600 may be partially or fully filled with the encapsulated material (e.g., the pellets 300, 400, and 500 of FIG. 3, FIG. 4, and FIG. 5, respectively) and then sealed. These measures will provide structural stability of the sealable containers 600, such as they are stacked.

The sealable containers 600, having sealed therein the encapsulated material (e.g., the pellets 300, 400, and/or 500 of FIG. 3, FIG. 4, and/or FIG. 5), may then be disposed of safely in a dedicated landfill 700 (stage 112 of FIG. 1), as illustrated in FIG. 7, for example and without limitation, such as a secure mercuric sulfide monofill in an authorized facility in an appropriate environment (e.g., a semi-arid or arid site). In such embodiments, even though the encapsulant material 204 of the encapsulated material (e.g., the pellets 300, 400, and/or 500 of FIG. 3, FIG. 4, and/or FIG. 5) may be alone sufficient to inhibit leaching of mercury from the mercuric sulfide particles 202 into neighboring areas, the sealable containers 600 increase the containment of the mercuric sulfide even further before the sealable containers 600 are buried at the dedicated landfill 700.

In other embodiments, the encapsulated material (e.g., the pellets 300, 400, and/or 500 of FIG. 3, FIG. 4, and/or FIG. 5) is directly disposed of at the dedicated landfill 700 without first sealing the material in the sealable containers 600 (stage 108 (FIG. 1)). In some such embodiments, stage 106 of FIG. 1 (encapsulating the mercuric sulfide in the encapsulant material 204) is followed by stage 112 (disposal in a dedicated landfill), bypassing stage 108 (sealing with the sealed sealable containers 600), as indicated by path 114.

Accordingly, disclosed is a method for treating and disposing of mercury from mercury-contaminated waste. The method comprises recovering high-purity mercury from mercury-contaminated waste. The high-purity mercury is converted to mercuric sulfide (HgS). The mercuric sulfide (HgS) is intermixed with a polymer-based material to form an encapsulated mercury material. The encapsulated mercury material is provided into a sealed waste container. The sealed waste container is provided into a landfill site.

With returned reference to the process 100 of FIG. 1, in some embodiments, the stages within box 116—from encapsulation of the mercuric sulfide in the encapsulant material—is performed by one entity, while another entity performs the prior stages (stage 102 and stage 104) outside of box 116. In other embodiments, a single entity or coordinating group of entities performs all of stages 102, 104, 106, optionally 108, and 112.

Accordingly, disclosed is a method for disposing of high-purity mercury recovered from mercury-contaminated waste. The method comprises encapsulating mercuric sulfide (HgS) in a polymer-based material to form an encapsulated-mercury material. The encapsulated-mercury material is sealed within a sealed container. The sealed container is disposed of within a landfill.

In some embodiments, the polymer material of both the encapsulant material 204 (FIG. 2) and the sealed sealable container 600 (FIG. 6) is a polyethylene material (e.g., linear polyethylene materials, such as LLDPE and HDPE, respectively). Linear polyethylene materials, such as LLDPE and HDPE, have only short branches along their polyethylene chain, resulting in close packing of molecules and relatively dense materials. HDPE has less chain branching than LLDPE producing a highly crystalline polymer. The structural properties of LLDPE and HDPE provide the low permeability and relatively high strength that result in their excellent resistance to ultraviolet (UV) radiation and chemical-induced degradation. With its greater branching, LLDPE is more flexible than HDPE. HDPE, in turn, has better UV and chemical resistance than LLDPE. The service life of LLDPE and HDPE materials is dependent on their formulations and their exposure conditions. For instance, the service life of polyethylene geomembranes exposed to atmospheric conditions with UV radiation, high temperatures, and oxygen is anticipated to be shorter than that of buried geomembranes. Because of their excellent durability for the mercury treatment process described herein, there is little potential for exposure of the LLDPE encapsulation material to UV radiation, because the treated product will be placed into sealed HDPE drums (e.g., sealable containers 600 (FIG. 6)) prior to transport to the landfill (e.g., dedicated landfill 700 (FIG. 7)). Further, when placed in the landfill (e.g., dedicated landfill 700 of FIG. 7), the LLDPE material (e.g., the encapsulant material 204 of FIG. 3 through FIG. 5) will be contained in HDPE drums (e.g., the sealable containers 600 of FIG. 6) and will not be in contact with water (precipitation, leachate, or groundwater), which could cause chemical-induced degradation. Further, after the drums (e.g., the sealable containers 600 (FIG. 6)) are isolated from the ambient environment by soil cover, the LLDPE (e.g., the encapsulant material 204 of FIG. 3 to FIG. 5) will be protected from thermal mechanisms of degradation. While the HDPE drums (e.g., sealable containers 600 of FIG. 6) may be subjected to UV radiation temperatures while they are being transported and placed in the landfill (e.g., the dedicated landfill 700 (FIG. 7)), after they are covered with soil, this degradation mechanism ceases. These drums (e.g., the sealable containers 600 (FIG. 6)) will not come into contact with any significant amount of liquids. Groundwater at the site (e.g., the dedicated landfill 700 (FIG. 7)) may be at about 300 feet (about 91 m) below ground surface (bgs), which may be well below the depth of the dedicated landfill 700 (e.g., up to about 20 feet (about 6 m)) bgs, so the only water that will contact the drums (e.g., the sealable containers 600 (FIG. 7)) may be small quantities of precipitation. As such, weathering or long-term degradation of the HDPE drums (e.g., the sealable containers 600 (FIG. 6) and LLDPE-encapsulated mercuric sulfide (e.g., the pellets 300, 400, and/or 500 of FIG. 3, FIG. 4, and/or FIG. 5) may be minimized to the extent possible. Further, the antioxidants added to the LLDPE and HDPE protect the materials from degradation.

Given that the LLDPE encapsulation material (e.g., the pellets 300, 400, and/or 500 of FIG. 3, FIG. 4, and/or FIG. 5) and HDPE drums (e.g., the sealable containers 600 (FIG. 6)) are not anticipated to have significant exposure to UV radiation or chemicals, the environmental condition that has the most effect on the service life of these products is service temperature. The dedicated landfill 700 (FIG. 7) may be constructed in a shallow excavation in an arid environment. As the mercuric sulfide (mercuric sulfide particles 202 (FIG. 3 to FIG. 5)) is not anticipated to undergo reactions that generate heat in the dedicated landfill 700, the temperature of the landfilled waste will approach the ground temperature. The HDPE of the drums (e.g., the sealable containers 600 (FIG. 7)) and the LLDPE of the encapsulated material (e.g., the encapsulant material 204 of the pellets 300, 400, and/or 500 of FIG. 3, FIG. 4, and/or FIG. 5)) is expected to have a sufficient service life for safe disposal.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope of the disclosure as contemplated. Further, embodiments of the disclosure have utility with different and various devices and materials.

What is claimed is:

1. A method for disposing of high-purity mercury recovered from mercury-contaminated waste, the method comprising:
encapsulating mercuric sulfide (HgS) in a polymer-based material to form an encapsulated-mercury material;
sealing the encapsulated-mercury material within a sealed container; and
disposing of the sealed container within a landfill.

2. The method of claim 1, further comprising, prior to encapsulating the mercuric sulfide (HgS) in the polymer-based material:
converting high-purity mercury (Hg), derived from the mercury-contaminated waste, into the mercuric sulfide.

3. The method of claim 1, wherein encapsulating the mercuric sulfide (HgS) in the polymer-based material comprises:
forming the encapsulated-mercury material to comprise pellets, at least one of the pellets comprising:
a core comprising at least one particle of the mercuric sulfide; and
a shell around the core, the shell comprising the polymer-based material.

4. The method of claim 1, wherein encapsulating the mercuric sulfide (HgS) in the polymer-based material comprises:
forming a mixture of a powder of the mercuric sulfide in the polymer-based material; and
extruding the mixture to form pellets comprising the mercuric sulfide powder within a matrix of the polymer-based material.

5. The method of claim 1, wherein the polymer-based material comprises polyethylene.

6. The method of claim 5, wherein the polyethylene comprises linear low-density polyethylene (LLDPE).

7. The method of claim 1, wherein the sealed container comprises a polymer-based container.

8. The method of claim 7, wherein the polymer-based container comprises high-density polyethylene (HDPE).

9. The method of claim 1, wherein the landfill is a monofill site dedicated to receiving mercury waste.

10. A method for treating and disposing of mercury-contaminated waste, the method comprising:
recovering high-purity mercury from mercury-contaminated waste;
converting the high-purity mercury to mercuric sulfide (HgS);
intermixing the mercuric sulfide (HgS) with a polymer-based material to form an encapsulated mercury material;
providing the encapsulated mercury material into a sealed waste container; and
providing the sealed waste container into a landfill site.

11. The method of claim 10, wherein converting the high-purity mercury to the mercuric sulfide (HgS) comprises forming a mercuric sulfide powder.

12. The method of claim 11, wherein intermixing the mercuric sulfide (HgS) with the polymer-based material to form the encapsulated mercury material comprises:
dispersing the mercuric sulfide powder within a matrix of the polymer-based material to form a mixture; and
forming solid particles of the encapsulated mercury material from the mixture.

13. The method of claim 10, wherein recovering the high-purity mercury from the mercury-contaminated waste comprises retorting the mercury-contaminated waste.

14. The method of claim 10, wherein the high-purity mercury comprises at least 99 wt. % elemental mercury (Hg).

15. A mercury-including waste product, comprising:
pellets, the pellets comprising mercuric sulfide within a polymer material.

16. The mercury-including waste product of claim 15, wherein the pellets each comprise particles of the mercuric sulfide substantially evenly distributed within a matrix of the polymer material.

17. The mercury-including waste product of claim 15, wherein the pellets each comprise:
a core comprising at least one particle of the mercuric sulfide; and
a shell surrounding the core and comprising the polymer material.

18. The mercury-including waste product of claim 17, wherein, in the core of the pellet, the at least one particle of the mercuric sulfide is disposed within a matrix material of the polymer material.

19. The mercury-including waste product of claim 15, further comprising a polymer-based container, the pellets being sealed therein.
